(19) United States
(12) Patent Application Publication
(10) Pub. No.: US 2007/0062930 A1
(43) Pub. Date: Mar. 22, 2007

(54) Method of controlling boiling level

(76) Inventors: Neil Swan, Bromsgrove (GB); Frederick James Davis, Droitwich (GB); Peter Ravenscroft Wilkins, Droitwich (GB)

Correspondence Address: Ira S. Dorman, 330 Roberts Street, Suite 200, East Hartford, CT, 06108, US

(21) Appl. No.: 10/572,768

(22) PCT Filed: Sep. 20, 2004
(86) PCT No.: PCT/GB04/04001

§ 371 Date: Sep. 29, 2006

(30) Foreign Application Priority Data
Sep. 23, 2003 (GB) 0322170.2

(51) Int. Cl. H05B 3/68

(52) U.S. Cl. 219/446.1

(57) ABSTRACT

A method is provided for controlling boiling level in an electric cooking assembly (2). The assembly (2) includes an electric heater (12) incorporating an electric heating element (20) and a temperature-responsive device (30) adapted to monitor temperature of the cooking utensil (8) and including a temperature sensing element (38). The assembly further includes manual input selection means (106) whereby a plurality of predetermined boiling levels are user-selectable. Each predetermined boiling level is associated with a predetermined temperature sensed by the temperature sensing element (38), the predetermined temperature being offset relative to an actual temperature representative of each respective boiling level. The boiling level is controlled by energising of the heater (12) at a corresponding power level.

This invention relates to a method of controlling boiling level in an electric cooking assembly. Such a cooking assembly comprises a cooking plate, such as of glass-ceramic material, having a lower surface in contact with which is supported an electric heater and an upper surface adapted to receive a cooking utensil, containing a material to be subjected to boiling, on a heating zone overlying the electric heater. The electric heater incorporates at least one electric heating element.

It is desirable to be able to provide different levels of boiling in the cooking utensil. For example, it may be required to maintain a gentle boil or simmer at a temperature of about 97 to 98 degrees Celsius, such as for cooking pasta or rice, to avoid boiling-over and also to avoid excessively rapid evaporation. A medium boiling level, at a temperature of about 98 to 100 degrees Celsius, may be required for cooking certain vegetables. Alternatively, a vigorous, high or rolling boiling level, at a temperature of around 100 degrees Celsius, may be required for maintaining high temperatures in the case of high bulk liquid volumes, such as in jam making.

Such control of boiling level requires accurate temperature control in a temperature range of 95 to 100 degrees Celsius and particularly from a temperature level at which latent heat of vaporisation effects start to occur. Satisfactory control cannot be achieved through open loop power level (duty cycle) control because of variables involved, such as cooking utensil quality, differences in cooking material mass and changes in cooking material thermal mass resulting from evaporation losses.

Closed loop control systems are known which directly monitor cooking utensil temperature using a sensor, such as an infrared sensor, located above the cooking plate. Such systems cannot control different boiling levels, because once the contents of the cooking utensil reach boiling point, the surface temperature of the cooking utensil does not change as more power is applied from the heater.

In such systems use may be made of a temperature-responsive device arranged substantially in contact with the lower surface of the cooking plate and adapted to monitor temperature of the cooking utensil through the cooking plate. The temperature-responsive device incorporates a temperature sensing element, having an electrical parameter which changes as a function of temperature and which is electrically connected to control means for operating in closed loop manner for controlling energising of the electric heater from a power supply. The temperature sensing element and a corresponding overlying region of the lower surface of the cooking plate are preferably shielded from direct thermal radiation from the heating element or elements in the electric heater.

Such an arrangement provides constant cooking temperature control at a range of temperatures and for a range of cooking utensil types and provides rapid thermal response when the assembly is operating in heating up, cooling and re-heating modes.

However, it has been found that such an arrangement does not function well at temperatures around boiling point because of the onset of latent heat of vaporisation effects.

It is therefore an object of the present invention to provide a method for controlling boiling level which overcomes the problems associated with effects resulting from the latent heat of vaporisation.

According to the present invention there is provided a method of controlling boiling level in an electric cooking assembly, the assembly comprising:
a cooking plate having a lower surface in contact with which is supported an electric heater and an upper surface adapted to receive a cooking utensil containing a material to be subjected to boiling on a heating zone overlying the electric heater;
the electric heater incorporating at least one electric heating element and a temperature-responsive device arranged substantially in contact with the lower surface of the cooking plate and adapted to monitor temperature of the cooking utensil;
the temperature-responsive device incorporating a temperature sensing element, having an electrical parameter which changes as a function of temperature, which is electrically connected to control means for controlling energising of the electric heater from a power supply; and
manual input selection means associated with the control means, whereby a plurality of predetermined boiling levels are user-selectable for the material in the cooking utensil,
the method including the steps of:
associating each predetermined boiling level with a predetermined temperature sensed by the temperature sensing element, the predetermined sensed temperature being offset relative to an actual temperature representative of each respective boiling level; and
controlling the boiling level of the material in the cooking utensil by energising the heater at a corresponding power level.

The predetermined sensed temperature may be offset relative to the actual temperature of each respective boiling level by a different amount.

The temperature-responsive device may be arranged substantially in contact with the lower surface of the cooking plate.

The cooking plate may comprise glass-ceramic material. The temperature sensing element may operate in closed loop manner with the control means, for controlling energising of the electric heater from the power supply.

Means may be provided to shield the temperature sensing element and a corresponding overlying region of the lower surface of the cooking plate from direct thermal radiation from the at least one electric heating element. Such means may comprise thermal insulation material.

The temperature-responsive device may be arranged substantially in contact with the lower surface of the cooking plate at a peripheral region of the heating zone.

The temperature sensing element may comprise a material, such as platinum, whose electrical resistance changes as a function of temperature and which may be provided in film form on a supporting substrate.

The control means may comprise microprocessor-based electronic circuitry.

The predetermined boiling levels may comprise a low or simmer boiling level, a medium boiling level and a high or rolling boiling level.

The low or simmer boiling level may be associated with a temperature sensed by the temperature sensing element in a range of about 140 to about 190 degrees Celsius. In particular, such low or simmer boiling level may be associated with a temperature sensed by the temperature sensing element of about 170 degrees Celsius.

The medium boiling level may be associated with a temperature sensed by the temperature sensing element in a range of about 160 to about 210 degrees Celsius. In particular, such medium boiling level may be associated with a temperature sensed by the temperature sensing element of about 190 degrees Celsius.

The high or rolling boiling level may be associated with a temperature sensed by the temperature sensing element above about 210 degrees Celsius. In particular, such high or rolling boiling level may be associated with a temperature sensed by the temperature sensing element of about 220 degrees Celsius.

Selection of the high or rolling boiling level may result in operation of the heater at substantially full power.

The manual input selection means may comprise one or more switch means.

For a better understanding of the present invention and to show more clearly how it may be carried into effect, reference will now be made by way of example to the accompanying drawings in which:

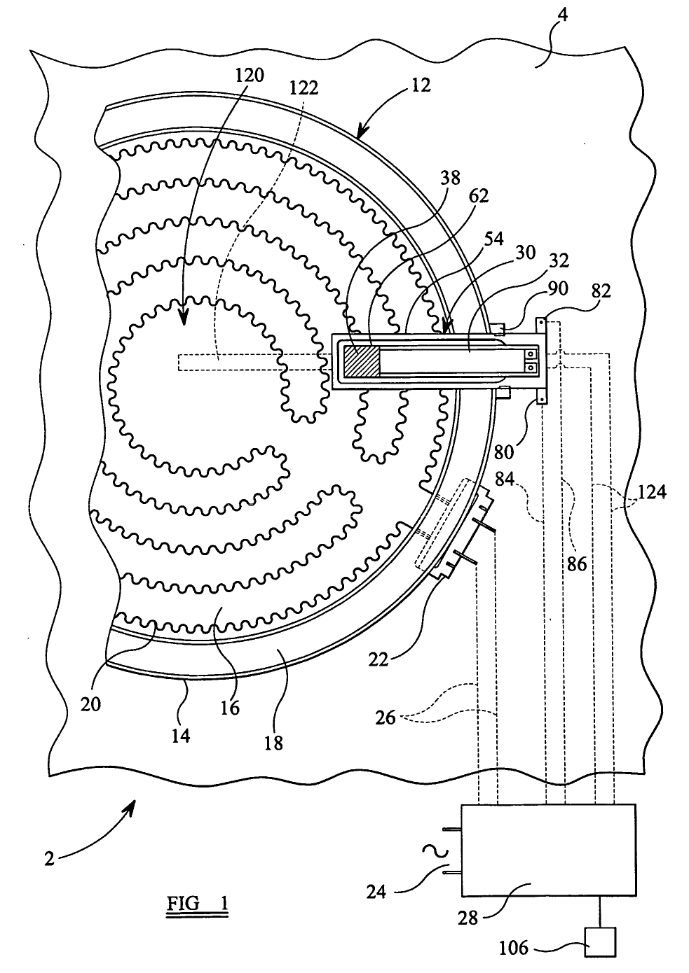

FIG. 1 is a plan view of an embodiment of an electric cooking assembly provided with an embodiment of apparatus for control of boiling level in accordance with the present invention;

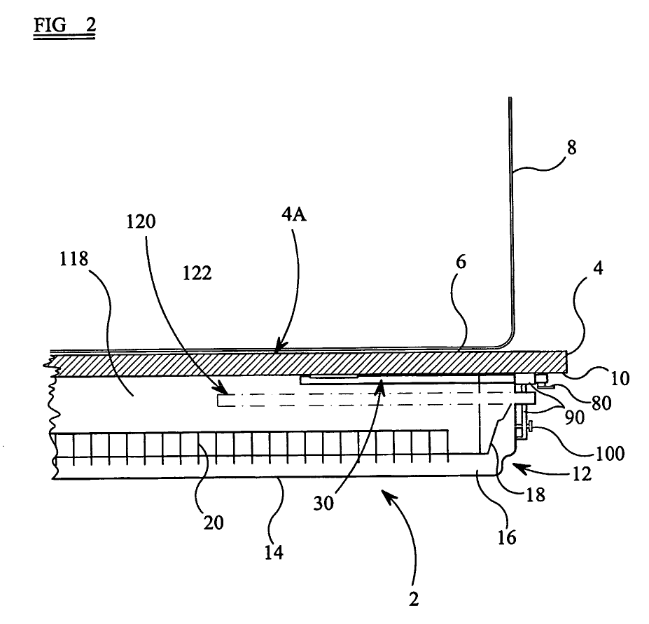

FIG. 2 is a cross-sectional view of the cooking assembly of FIG. 1;

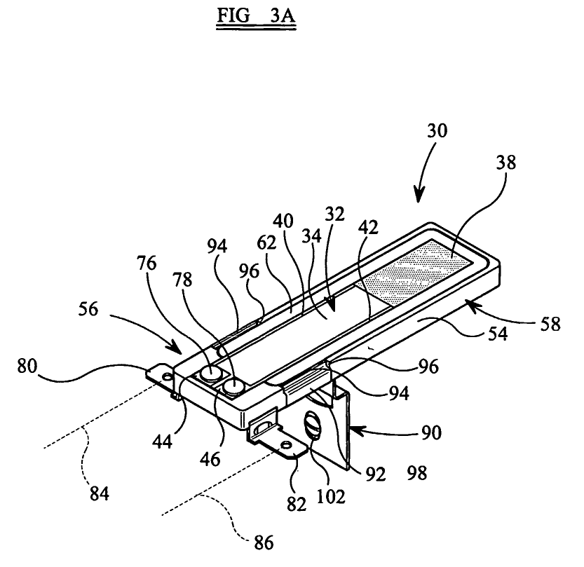

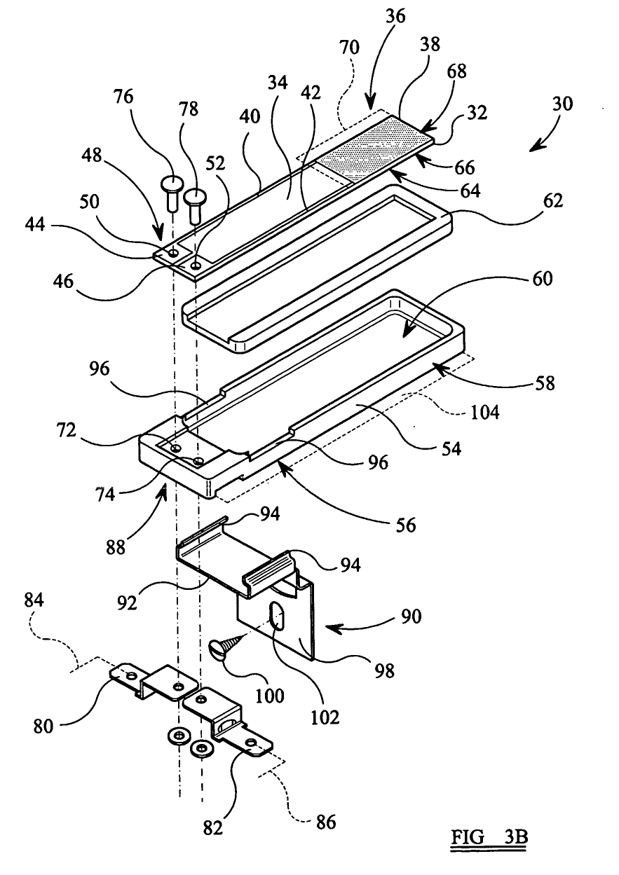

FIG. 3A is a perspective view of an embodiment of a temperature-responsive device for use in the assembly of FIGS. 1 and 2;

FIG. 3B is an exploded view of the temperature-responsive device of FIG. 3A; and

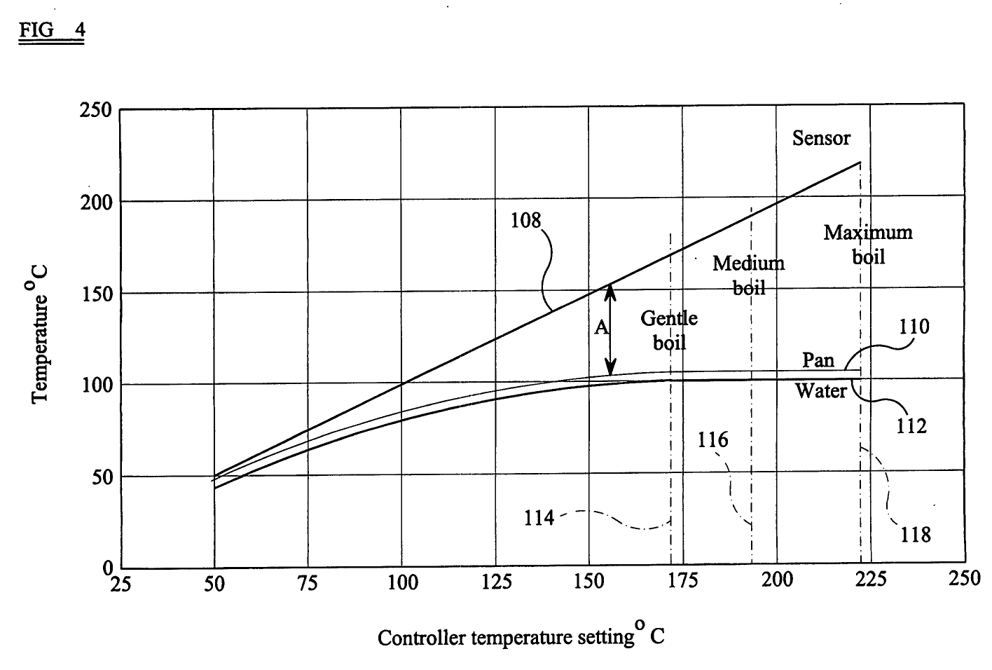

FIG. 4 is a graph illustrating temperatures sensed by a temperature sensing element in the temperature-responsive device of the cooking assembly of FIGS. 1 and 2 in comparison with temperatures of a cooking utensil and contents being heated, for various user-selectable manual input controller temperature settings of the apparatus.

Referring to FIGS. 1 and 2, an electric cooking assembly 2 comprises a glass-ceramic cooking plate 4 of well known form, having an upper surface 6 for receiving a cooking utensil 8, such as a pan, containing a material to be subjected to boiling. A lower surface 10 of the cooking plate 4 has an electric heater 12 supported in contact therewith. The electric heater 12 comprises a dish-like support 14, such as of metal, in which is provided a base layer 16 of thermal and electrical insulation material, such as microporous thermal and electrical insulation material. A peripheral wall 18 of thermal insulation material is arranged to contact the lower surface 10 of the cooking plate 4.

At least one radiant electrical resistance heating element 20 is supported relative to the base layer 16. The heating element or elements can comprise any of the well known forms of heating element, such as wire, ribbon, foil or lamp forms, or combinations thereof. In particular, the heating element or elements 20 can be of corrugated ribbon form, supported edgewise on the base layer 16 of insulation material.

A terminal block 22 is provided at an edge region of the heater 12, for connecting the heating element or elements 20 to a power supply 24 by way of leads 26 and through a control means 28, which may be a microprocessor-based control arrangement.

The cooking utensil 8 is heated by the heating element or elements 20 and its temperature is monitored by a temperature-responsive device 30, which is located in contact with the lower surface 10 of the cooking plate 4, at a peripheral region of a heating zone 4A of the cooking plate 4 overlying the heater 12.

The construction of one particular embodiment of the temperature-responsive device 30 is shown in FIGS. 3A and 3B.

Referring to FIGS. 3A and 3B, the temperature-responsive device 30 comprises a substantially planar thin elongate ceramic substrate 32 having an upper surface 34 and provided at a first end region 36 thereof with a temperature-sensitive electrical resistance element 38 of film form and suitably comprising platinum. The resistance element 38 may be deposited onto the surface 34 of the substrate 32 by a thick film printing technique.

Electrical connecting leads 40, 42, also of film form, are provided on the upper surface 34 of the substrate 32 and are electrically connected to the temperature-sensitive electrical resistance element 38. The electrical connecting leads 40, 42 suitably comprise the same or similar material as the electrical resistance element 38 and extend to terminal pads 44, 46 provided at a second end region 48 of the substrate 32. The terminal pads 44, 46 may comprise substantially the same or similar material as the electrical connecting leads 40, 42 or may comprise a different material, such as gold. Holes 50, 52 are provided through the pads 44, 46 and through the substrate 32.

An elongate support member 54, arranged as a beam, is adapted to extend at least partly across the heater 12 from a peripheral region of the heater, across an aperture or recess in the peripheral wall 18 and a rim of the dish-like support 14, with a first end 56 of the support member secured externally of the heater at the peripheral region of the heater and with a second end 58 thereof located within the heater. The support member 54 suitably comprises a ceramic material, such as steatite, cordierite or alumina, and is provided with an elongate recess 60 into which is received the substrate 32, such that the temperature-sensitive electrical resistance element 38 is located at or near the second end 58 of the support member 54 within the heater 12 and the terminal pads 44, 46 are located externally of the heater, at the first end 56 of the support member, where they are subjected to a relatively low temperature.

Thermal insulation means 62 is provided in the recess 60 in the support member 54, interposed between the support member 54 and a lower surface 64 and side edges 66, 68 of the substrate 32. The thermal insulation means 62 preferably comprises a thin layer of microporous thermal insulation material, suitably of a thickness between 1 and 4 mm and preferably between 2 and 3 mm. Alternatively or additionally, the thermal insulation means 62 could comprise granular thermal insulation material, such as vermiculite or calcium silicate.

The substrate 32 and thermal insulation means 62 may be press-moulded into the recess 60 in the support member 54, such that the upper surface 34 of the substrate 32 is substantially planar with that of the support member 54.

The thermal insulation means 62 serves to shield the temperature-sensitive electrical resistance element 38 and a corresponding overlying region of the lower surface 10 of the cooking plate 4 from direct thermal radiation from the heating element or elements 20.

An electrically insulating or passivation layer 70 may be provided on the upper surface 34 of the ceramic substrate 32, at least overlying the temperature-sensitive electrical resistance element 38.

Holes 72, 74 are provided through the support member 54 at the first end 56 thereof. The holes 72, 74 are aligned with the holes 50, 52 in the ceramic substrate 32 and are arranged to receive electrically connecting members 76, 78, suitably comprising bolts, pins or rivets, for electrically connecting the terminal pads 44, 46 to terminal tabs or pins 80, 82 and for mechanically securing the ceramic substrate 32 to the support member 54. The terminal tabs or pins 80, 82 are arranged for electrically connecting the temperature-sensitive electrical resistance element 38 to the control means 28 by means of leads 84, 86. When the electrically connecting members 76, 78 comprise bolts, such bolts suitably comprise brass, plated with silver or nickel. When the electrically connecting members 76, 78 comprise rivets, such rivets suitably comprise copper, plated with gold.

The terminal tabs or pins 80, 82 are arranged to extend laterally at the first end 56 of the support member 54 and from a lower surface 88 of the support member 54, whereby adequate electrical clearance is provided between the terminal tabs or pins 80, 82 and the lower surface of the cooking plate 4.

A metal mounting bracket 90 is provided for the temperature-responsive device 30. The mounting bracket 90 suitably comprises stainless steel and has a first portion 92 arranged with clip means 94 securely engaging portions 96 of the first end 56 of the support member 54 provided as recesses or rebates in the support member 54. The mounting bracket 90 has a second portion 98 secured to the rim of the dish-like support 14 of the heater 12 by means of a threaded fastener 100 passing through a hole 102 in the second portion 98 of the mounting bracket 90. The mounting bracket 90 is provided of cantilevered form from a single bent sheet or strip of metal and such that the second end 58 of the support member 54 is spring-biased towards the lower surface 10 of the cooking plate 4, whereby the upper surface of the temperature-responsive device 30 is maintained substantially in contact with the lower surface 10 of the cooking plate 4.

The external lower surface 88 of the support member 54 may be provided with a layer 104 of thermal radiation-reflecting material to reflect thermal radiation incident from the heating element or elements 20.

The temperature-responsive device 30 has its temperature-sensitive electrical resistance element 38 electrically connected in closed loop manner with the control means 28, for controlling energising of the electric heater 12 from the power supply 24.

The temperature-responsive device 30 monitors the temperature of the cooking utensil 8 and sensed temperature data is supplied from the temperature-sensitive electrical resistance element 38 to the control means 28.

A manually operated controller 106, such as comprising one or more switch means, is provided in association with the control means 28 and serves for manual input selection by a user of desired heating states of the cooking utensil 8 and its contents. Constant cooking temperature control at a range of temperatures and for a range of types of cooking utensil 8 is provided with the resulting cooking assembly and rapid thermal response is provided when the assembly is operating in heating up, cooling and re-heating modes.

At temperatures close to boiling, it is found that the proportion of power applied to the heater 12 has to be increased against that expected for a particular amount of material being heated in the cooking utensil 8 as energy is absorbed associated with latent heat of vaporisation of the material contents, such as water, of the cooking utensil 8. An offset occurs between the actual temperature of the cooking utensil and contents and the temperature actually sensed by the temperature-sensitive electrical resistance element 38 in the temperature-responsive device 30. The offset occurs as a result of a small amount of thermal energy being conducted to the temperature-sensitive electrical resistance element 38 through the thermal insulation means 62 in the temperature-responsive device 30, at high heater power levels. It also occurs as a result of heat being conducted to the element 38 through the cooking plate 4, once the temperature of the cooking utensil 8 has reached a constant level.

The temperature offset effect is illustrated in FIG. 4, which is a graphical representation of temperature against temperature setting of the controller 106. It should be noted the controller may not, in practice, have a specific temperature setting, but may alternatively have a setting in the range from 1 to 9 or another suitable range. Curve 108 represents the temperature sensed by the temperature-sensitive electrical resistance element 38. Curve 110 represents the actual temperature of the cooking utensil (pan) 8 and curve 112 represents the actual temperature of water contents in the cooking utensil 8. The offset A occurring between the actual temperature of the cooking utensil 8 and the temperature sensed by the temperature-sensitive electrical resistance element 38, is determined in practice by laboratory experiment and increases as the level of boiling in the cooking utensil 8 increases. In the present invention this is used to provide controlled power levels of the heater 12 consistent with different predetermined boiling levels manually selected by a user operating the controller 106.

By way of example, three boiling levels may be selectable, as indicated by settings 114, 116 and 118 in FIG. 4. Setting 114 provides a low, gentle or simmer boiling level. When this setting is selected, the control means 28 is programmed to control the heater 12 to maintain a temperature sensed by the temperature-sensitive electrical resistance element 38 of between about 140 and about 190 degrees Celsius, and suitably of about 170 degrees Celsius.

Setting 116 provides a medium boiling level. When this setting is selected, the control means 28 is programmed to control the heater 12 to maintain a temperature sensed by the temperature-sensitive electrical resistance element 38 of between about 160 and about 210 degrees Celsius, and suitably of about 190 degrees Celsius.

Setting 118 provides a vigorous, maximum, high or rolling boiling level. When this setting is selected, the control means is programmed to control the heater 12 to maintain a temperature sensed by the temperature-sensitive electrical resistance element 38 of above about 210 degrees Celsius, and suitably of about 220 degrees Celsius. Selection of this setting 118, to provide the vigorous, maximum, high or rolling boiling level, suitably results in the control means 28 operating the heater 12 at substantially full power.

A further temperature-responsive device 120 may be provided in the heater 12, having a rod-like or beam-like sensing portion 122 arranged to extend at least partly across the heater 12 from a peripheral region of the heater. Such further temperature-responsive device 120 is suitably electrically connected to the control means 28 by way of connecting leads 124 and may serve for controlling the temperature of the cooking plate 4 within predetermined limits, for example for preventing thermal damage to the cooking plate 4. The device 120 may be an electro-mechanical device of known form or an electronic probe incorporating a temperature-sensitive electrical resistance element.

Thus the present invention is based on an appreciation that, at temperatures close to boiling, the proportion of power applied by the heater has to be increased against that expected for the particular amount of material in the cooking utensil, as a result of onset of latent heat of vaporisation effects. Consequently an offset occurs between the actual cooking utensil temperature and the temperature sensed by the temperature sensing element in the temperature-responsive device. This offset in temperature increases as the boiling level increases and it has been found that the offset can be monitored and processed to provide controlled heater power levels consistent with different boiling levels.

1. (canceled)

2. (canceled)

3. A method according to claim 22, wherein the temperature-responsive device (30) is arranged substantially in contact with the lower surface (10) of the cooking plate (4).

4. A method according to claim 22, wherein the cooking plate (4) comprises glass-ceramic material.

5. A method according to claim 22, wherein the temperature sensing element (38) operates in closed loop manner with the control means (28), for controlling energising of the electric heater (12) from the power supply (24).

6. A method according to claim 22, wherein means (62) is provided to shield the temperature sensing element (38) and a corresponding overlying region of the lower surface (10) of the cooking plate (4) from direct thermal radiation from the at least one electric heating element (20).

7. A method according to claim 6, wherein the shielding means (62) comprises thermal insulation material.

8. A method according to claim 22, wherein the temperature-responsive device (30) is arranged adjacent to the lower surface (10) of the cooking plate (4) at a peripheral region of the heating zone (4A).

9. A method according to claim 22, wherein the temperature sensing element (38) comprises a material whose electrical resistance changes as a function of temperature.

10. A method according to claim 9, wherein the material is provided in film form on a supporting substrate (32).

11. A method according to claim 9, wherein the material comprises platinum.

12. A method according to claim 22, wherein the control means (28) comprises microprocessor-based electronic circuitry.

13. A method according to claim 22, wherein the predetermined boiling levels comprise a low or simmer boiling level, a medium boiling level and a high or rolling boiling level.

14. A method according to claim 13, wherein the low or simmer boiling level is associated with a temperature sensed by the temperature sensing element (38) in a range of about 140 to about 190 degrees Celsius.

15. A method according to claim 14, wherein the low or simmer boiling level is associated with a temperature sensed by the temperature sensing element (38) of about 170 degrees Celsius.

16. A method according to claim 13, wherein the medium boiling level is associated with a temperature sensed by the temperature sensing element (38) in a range of about 160 to about 210 degrees Celsius.

17. A method according to claim 16, wherein the medium boiling level is associated with a temperature sensed by the temperature sensing element (38) of about 190 degrees Celsius.

18. A method according to claim 13, wherein the high or rolling boiling level is associated with a temperature sensed by the temperature sensing element (38) above about 210 degrees Celsius.

19. A method according to claim 18, wherein the high or rolling boiling level is associated with a temperature sensed by the temperature sensing element (38) of about 220 degrees Celsius.

20. A method according to claim 13, wherein selection of the high or rolling boiling level results in operation of the heater (12) at substantially full power.

21. A method according to claim 22, wherein the manual input selection means (106) comprises one or more switch means.

22. A method of controlling boiling level in an electric cooking assembly (2), the assembly comprising:
a cooking plate (4) having a lower surface (10), in contact with which is supported an electric heater (12), and an upper surface (6) adapted to receive a cooking utensil (8) containing a material to be subjected to boiling on a heating zone (4A) overlying the electric heater;
the electric heater incorporating at least one electric heating element (20) and a first temperature-responsive device (120) for controlling the temperature of the cooking plate (4) within predetermined limits;
control means (28) for controlling energising of the electric heater from a power supply (24); and
manual input selection means (106) associated with the control means, the method comprising the steps of:
providing a second temperature-responsive device (30) arranged adjacent to the lower surface of the cooking plate and adapted to monitor temperature of the cooking utensil through the cooking plate, the second temperature-responsive device incorporating a temperature sensing element (38) having an electrical parameter which changes as a function of temperature and which is electrically connected to the control means (28);
providing on the manual input selection means (106) a plurality of predetermined user-selectable boiling levels for the material in the cooking utensil;
associating in the control means (28) each predetermined boiling level with a predetermined temperature sensed by the temperature sensing element (38), the predetermined sensed temperature being offset relative to an actual temperature representative of each respective boiling level, the offset being different for each respective boiling level; and
controlling the boiling level of the material in the cooking utensil (8) by energising the heater (12) at a corresponding power level.
